(19) United States
(12) Patent Application Publication
(10) Pub. No.: US 2024/0169850 A1
(43) Pub. Date: May 23, 2024

(54) Method and Apparatus for Enhanced Mindfulness and Mental Health

(71) Applicant: Deanna DeAndino, Wall Township, NJ (US)

(72) Inventor: Deanna DeAndino, Wall Township, NJ (US)

(21) Appl. No.: 18/492,030

(22) Filed: Oct. 23, 2023

Related U.S. Application Data
(60) Provisional application No. 63/475,589, filed on Nov. 23, 2022.

(51) Int. Cl. G09B 1/02; G09F 7/18

(52) U.S. Cl. CPC G09B 1/02; G09F 7/18; A47G 1/02

(57) ABSTRACT

An apparatus having interactive features and a method for its use in promoting mirror talk with positive affirmations. The apparatus can include a body panel, a mirror, a storage compartment, and a number of tags that bear a message. The device is intended to be used by a person standing in front of the mirror and reading one or more messages on the tags, such as on a daily basis using a different tag each day, under the guidance of a caregiver.

### CROSS-REFERENCE

This application claims the priority benefit of U.S. Provisional Application No. 63/475,589, filed Nov. 23, 2022 and entitled METHOD AND APPARATUS FOR ENHANCED MINDFULNESS & MENTAL HEALTH, the entirety of which is hereby incorporated herein for all purposes.

### FIELD

This application, disclosure, claims, & embodiments generally relate to an apparatus and method for interacting with an individual in a manner to promote positive self-affirmation, and more particularly, a method and apparatus to encourage children regular self-affirmation in children and young people.

### BACKGROUND

There are many types of apparatus and methods suitable for use in environments and scenarios where the encouragement and uplifting of children is necessary. Research suggests that such apparatus and methods are quintessential to the development of young people, and that the absence of such apparatus and methods markedly disrupts mental development.

The mental health of children during youth is directly related to their propensity to reach developmental and emotional milestones and their ability to learn healthy social skills. Further, Positive mental well-being increases a child's ability to cope with issues and challenges that they will face during adolescence and adulthood. Mentally healthy children have a positive quality of life and can function well at home, in school, and in their communities. Thus, it is critical to incorporate methods and apparatus that are able to enhance the mindfulness and mental health of such young people.

Mental health is considered an essential part of children's overall health. It often is associated with a complex relationship of their physical health, ability to succeed in school, at work, and in society. Both physical and mental health affect how children and adults think, feel and act. Further, mental health is important throughout childhood. It has been shown that certain elements and tools are able to promote a positive environment and mental state that facilitates the development of positive mental influences.

It has long been studied that the interaction between people and apparatus is significantly more influential on the mental health of individuals. Further, apparatus and methods that specifically incorporate certain elements are more suitable for manipulating the emotional and mental well-being of a child.

All children have the right to happy and healthy lives and deserve access to effective care to ensure that proper mental well-being and mindfulness is present. Numerous attempts have been made to improve such apparatus and method for the same. Accordingly, there exists a need for an apparatus or method to enhance the mindfulness & mental health of all types of individuals, and in particular, young people.

This background information is provided for the purpose of making information believed by the applicant to be of possible relevance to the present disclosure. Notwithstanding, no admission is necessarily intended, nor should it be construed, that any of the preceding information constitutes prior art against the present disclosure. In addition, the preceding information should not be construed to mean that a search has been made or that no other pertinent information as defined in 37 CFR § 1.56(a) exist.

### SUMMARY

The present disclosure provides an apparatus and method for promoting mindfulness and mental or psychological well-being, particularly in children. The apparatus supports a mirror and stores a plurality of affirmation tags for the user to removably attach to one or more tag holders next to the mirror. This facilitates the user reciting an affirmation corresponding to a tag that the user selects from storage and attaches to the mirror as a regular routine, such as on a daily basis with the guidance of a caregiver.

According to an aspect of the disclosure, the apparatus comprises a body panel, at least one mirror, a storage compartment, and a plurality of tags. The body panel has a front side defining a forward direction, an upper end defining a vertical upward direction, a lower end defining a vertical downward direction, lateral sides defining opposed lateral directions, and a rear side defining a rearward direction, the front side including a configurable display region and a storage region, a frontal area of the front side encompassing a frontal area of the configurable display region and a frontal area of the storage region. The mirror is disposed in the configurable display region. Each tag has a front side bearing message indicia. At least one tag holder is disposed on the front side of the body panel in the configurable display region, each tag being detachably attachable to the at least one tag holder so that the front side of the tag faces forward. The storage compartment is disposed in the storage region and is configured to store at least one tag.

According to another aspect of the disclosure, a method for encouraging the use of positive affirmations with mirror talk comprises using the apparatus of the present disclosure. The method includes selecting a tag having suitable message, reciting the message while looking into the mirror, and attaching the tag to the tag holder. In embodiments, the method further includes interacting with a caregiver.

According to another aspect of the disclosure, a method for encouraging positive psychological development is implemented by a processor on an electronic device. The method includes presenting a user interface prompting a user to select a phrase from a plurality of phrases, receiving user input representing the user's selection of a phrase, and rendering the phrase on an audio device.

### BRIEF DESCRIPTION OF THE DRAWINGS

The advantages and features of the present disclosure will become better understood with reference to the following more detailed description and claims taken in conjunction with the accompanying drawings, in which like elements are identified with like symbols, and in which:

FIG. 1 is a front view of a mindfulness and mental health apparatus according to an embodiment.

FIG. 2 is a left side elevation view of the apparatus shown in FIG. 1.

FIG. 3 is a rear view of the apparatus shown in FIG. 1.

FIG. 4 is an top-front-left isometric view of the apparatus shown in FIG. 1.

FIG. 5 is a truncated left-side elevation view of the apparatus shown in FIG. 1.

FIG. 6A is a top-front-left perspective view of a tag for use with the apparatus shown in FIG. 1 according to an embodiment.

FIG. 6B is a left-side elevation view of the tag shown in FIG. 6A.

FIG. 6C is a bottom-rear-right perspective view of the tag shown in FIG. 6A.

FIG. 7 is a top-front-left perspective view of another tag for use with the apparatus shown in FIG. 1 according to an embodiment of the disclosure.

FIG. 8A is a left-side exploded elevation view of a tag and a truncated cross section of a body of the apparatus shown in FIG. 1, illustrating an exemplary method of connecting the tag to a receptacle of the apparatus body.

FIG. 8B is a left-side elevation view of the tag and truncated apparatus body cross section of FIG. 8A in a connected configuration.

FIG. 9A is a front view of a mindfulness and mental health apparatus according to another embodiment, shown in a use configuration with tags detachably attached to a body of the apparatus adjacent a mirror.

FIG. 9B is a front view of the apparatus shown in FIG. 9A, shown in a setup configuration, with a closeable storage cover panel opened to reveal a selection of stowed tags detachably attached to a region of the apparatus body covered by the closed storage cover panel of the apparatus as shown in FIG. 9A.

### DETAILED DESCRIPTION

For the purposes of promoting an understanding of the principles of the disclosure, reference will now be made to certain embodiments and specific language will be used to describe the same. It will nevertheless be understood that no limitation of the scope of the disclosure is thereby intended, and alterations and modifications in the illustrated disclosure, and further applications of the principles of the disclosure as illustrated therein are herein contemplated as would normally occur to one skilled in the art to which the disclosure relates.

Unless defined otherwise, all technical and scientific terms used herein have the same meaning as commonly understood by one of ordinary skill in the art to which this disclosure pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and intended to be open-ended. Furthermore, in some specific instances where the description uses the term “comprising,” those skilled in the art will understand that the disclosure encompasses an embodiment or embodiments that would be described by substituting the language “consisting essentially of” and/or “consisting of.”

As used herein, the term “about” refers to a ±10% variation from the nominal value. It is to be understood that such a variation is always included in any given value provided herein, whether or not it is specifically referred to.

As used herein, the term “Affirmation” generally refers to the act or an instance of affirming, or a state of being affirmed wherein some positive statement is rendered.

As used herein, the term “Audio features” generally refers to a feature that is coexistent with an apparatus defined by an audible sound. In some embodiments, an audio feature is a response rendered by a processor.

As used herein, the term “Caregiver” generally refers to a person that is in charge or oversees in some capacity the development of another.

As used herein, the term “Classroom” generally refers to any place where one learns or gains experience. In some embodiments, it refers to a room, as in a school or college, in which instruction or learner development is held.

As used herein, the term “Tag” generally refers to an article having an ornamental design. In some embodiments, the tag contains text, an image, or other representation. In some embodiment, the term generally refers to a digital picture of symbol that appears on a screen and is used in a representative manner.

As used herein, the term “Interactive features” generally refers to a processor-operated system that actively responds to initial input.

As used herein, the term “Mantra” generally refers to a word, formula, or phrase that is repeated at least once. In certain embodiments, such a phrase is a truism.

As used herein, the term “Meditation” generally refers to continued or extended thought. Reflection or contemplation.

As used herein, the term “Mindfulness” generally refers to the state or quality of being mindful or aware. In certain embodiments, the term refers to focusing one's full attention to present thoughts, feelings, and sensations.

As used herein, the term “Tapestry” generally refers to an article comprising of a design, often pictorial that is suspended on a wall or surface.

As used herein, the term “Well-being” generally refers to a good or satisfactory condition of existence, or a state characterized by positive mental health.

It will be readily understood that the components of the present disclosure, as generally described and illustrated in the figures herein, may be arranged and designed in a wide variety of different configurations. Thus, the following detailed description of the embodiments, as represented in the attached figures, is not intended to limit the scope of the disclosure as claimed but is merely representative of selected embodiments of the disclosure.

The features, structures, or characteristics of the disclosure described throughout this specification may be combined in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment of the present disclosure. Thus, appearances of the phrases “example embodiments,” “in some embodiments,” “in other embodiments,” or other similar language, throughout this specification do not necessarily all refer to the same group of embodiments, and the described features, structures, or characteristics may be combined in any suitable manner in one or more embodiments.

The present disclosure generally relates to improved methods and apparatus for increasing the mental well-being and of a user. The apparatus and methods of the present disclosure utilize a system having a tactile, kinesthetic, and interactive component that engages the user in an immersive experience. Such an assimilation of techniques is more suitable for increasing the well-being of an individual. Advantageously, such apparatus and methods can, in certain embodiments, be adapted for use in a classroom or instructional setting.

In one embodiment an apparatus is provided having a surface which defines the body and a plurality of interactive tags that are situated in such a way as to allow securable relocation. Further included is at least one mirror and at least one pocket configured to receive at least one tag. In some embodiments, the tags would have a phrase or a mantra printed thereon. In other embodiments, the tags would have a picture or an image. It is envisioned that with such an arrangement, the apparatus could be useful for increasing the mental well-being of a user. Advantageously, an apparatus of the type described heretofore includes a tactile, kinesthetic, and interactive element while so engaged with a user providing a greater extent of experience.

In one embodiment, a method is provided, the method includes using the apparatus of the present disclosure to increase the mental well-being of a user. A further exemplary embodiment of such a method includes, in a routine fashion, selecting a tag that has a mantra, phrase, image, or the like, and relocating the tag to a position determined by the user or as user. After the tag is relocated, the user may optionally recite or reaffirm the mantra. Further optional, the user may interact with the mirror.

In some arrangements, an electronic configuration of the apparatus as disclosed is envisioned. In such an embodiment, the apparatus may include at least one processor and optionally at least one screen. While the apparatus retains similar functionality, it is envisioned that the mirror may be replaced with a screen adapted for telecommunication with an optional second user. In an exemplary embodiment, at least one section of the apparatus comprises an interactive screen wherein the tags are rendered and interacted with electronically.

In one aspect, the present disclosure provides a system for integration via a cell phone, a tablet, an interactive electronic apparatus or the like, said method comprising applying said apparatus and methods via a programmable “app” having features similar to those described herein.

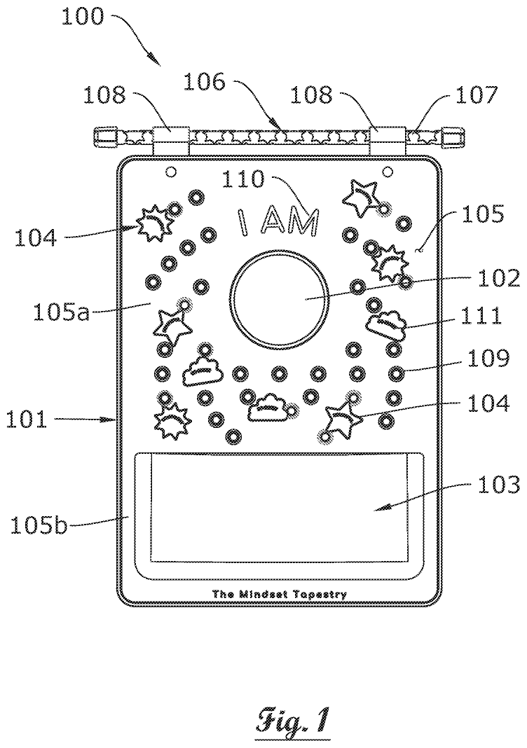

FIG. 1 depicts a front view of an exemplary embodiment of the apparatus 100 comprising a body panel 101, a mirror 102, a pocket 103, and a plurality of attachable affirmation tags 104. The body panel 101 is a generally flat panel having a front side 105 comprising a planar front surface. In some embodiments, the front side 105 is configurable in size and dimension. It is envisioned that in certain embodiments, the body panel 101 is constructed from the group selected from one or more of wood, metal, polymers, or organics. In an embodiment, the body panel 101 is a sheet of a flexible material such as vinyl or a woven natural or synthetic fabric or cloth material, for example, canvas. In certain embodiments, the body panel 101 is a tapestry. The body panel 101 includes a configurable display region 105a and a storage region 105b offset from the configurable display region 105a. More particularly, the configurable display region 105a is comprised in an area spanning a width of the front side 105 and extending from an upper end of the front side 105 to an upper end of the storage region 105b, while the storage region 105b is comprised in an area spanning a width of the front side 105 and extending from a lower end of the configurable display region 105a to a lower end of the front side 105. In other embodiments not shown, a storage region can instead be positioned above, to one side, or surrounding a configurable display region, for example, or even behind a configurable display region on a rear side of a body panel.

The mirror 102 is disposed on the front side 105 within the configurable display region 105a, the mirror 102 being situated so that a user's reflection is visible in the mirror 102 when the user faces the front side 105. In embodiments, an apparatus for promoting psychological well-being can include more than one mirror disposed within a configurable display region. Also disposed on the front side 105 within the configurable display region 105a are a plurality of tag holders 109 for detachably attaching selected tags 104 to be displayed during use of the apparatus 100 in a method according to an embodiment. It is envisioned that the arrangement of mounting points 109 can be arbitrary or situated in a particular pattern. Preferably, the mounting points 109 are close enough to the mirror 102 so that the mirror 102 and the mounting points 109 collectively fit within the field of vision of a user of normal unaided vision at a comfortable viewing distance, such as twelve to twenty-four inches forward, from the front side 105 of the apparatus 100.

The apparatus 100 further includes body panel message indicia 110 disposed on the front side 105 within the configurable display region 105a, the indicia 110 combining with the tags 104 to form one or more messages. More particularly, the tags 104 include tag message indicia 111 disposed on their front sides, the body panel indicia 110 combining with the tag indicia 111 to form a message, and still more particularly, the indicia 110 combine with the indicia 111 disposed on the front side of each tag 104 to form a separate message, so that when a plurality of the tags 104 are attached to the tag holders 109, a corresponding plurality of separate messages are formed. Specifically, the indicia 110 and 111 both comprise lettering forming words, the words of the indicia 110 followed by the words of the indicia 111 on each tag 104 form a separate sentence. More specifically, the indicia 110 form the words “I AM,” and the indicia 111 on each tag 104 form words representing a positive attribute, such as “BEAUTIFUL,” “SO SMART,” or “CONFIDENT.” Thus, in a method of using the apparatus 100 according to an embodiment, a user speaks or reads the words of the indicia 110 followed by the words of the indicia 111 on each tag 104 while facing the front side 105 of the apparatus 100, thus reciting a plurality of self-affirming statements to the user's own reflection in the mirror 102.

The apparatus 100 further includes a storage compartment illustrated as a pocket 103 disposed on the front side 105 within the storage area 105b. The pocket 103 is adapted to contain at least one tag 104. It is envisioned that tags 104 can be stored in the pocket 103 whenever not in use, selected and drawn from the pocket 103 for use, and deposited in the pocket 103 for storage after use.

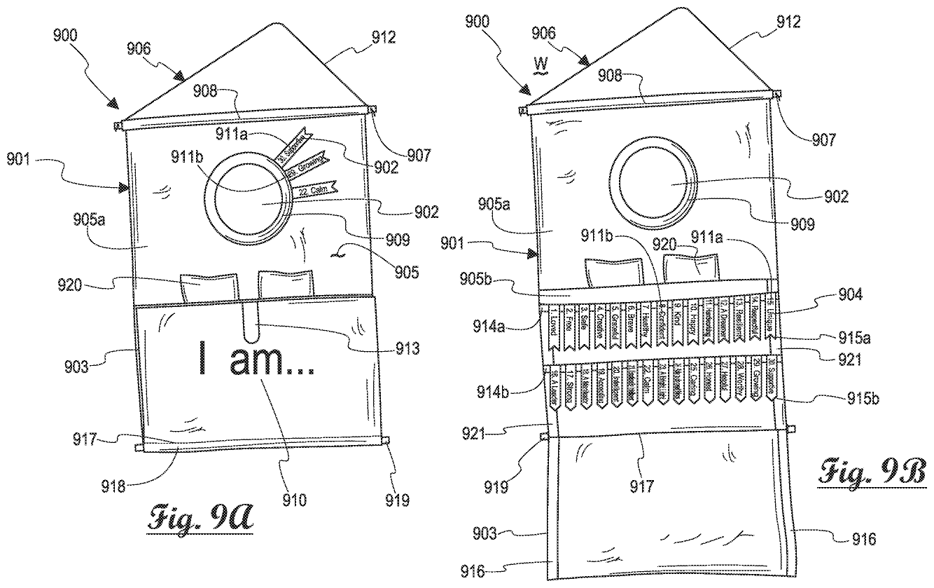

Continuing with FIG. 1, the apparatus 100 further includes a mount 106. More particularly, the mount 106 is a rod mount which comprises a rod 107 and retaining brackets 108, the retaining brackets 108 being affixed to an upper end of the body panel 101 and retaining the rod 107 above the body panel 101. Thus, the body panel 101 is adapted and configured to be suspended by the retaining brackets 108 from the rod 107 when the rod 107 is secured to a fixed support, such as a vertical wall (not shown), for example by placing the rod 107 over two or more wall hooks (not shown), or by frictionally retaining the rod in compression between two vertical support surfaces (such as the sides of a windowsill, doorframe, or similar rectangular frame structure, not shown). In other embodiments, a mount similar to the mount 106 can further include a cord (not shown) attached to a rod at or near its opposite ends, so that the rod can be hung from a suitable hook, peg, nail or similar (not shown), analogously to the apparatus 900 shown and described below with reference to FIGS. 9A and 9B.

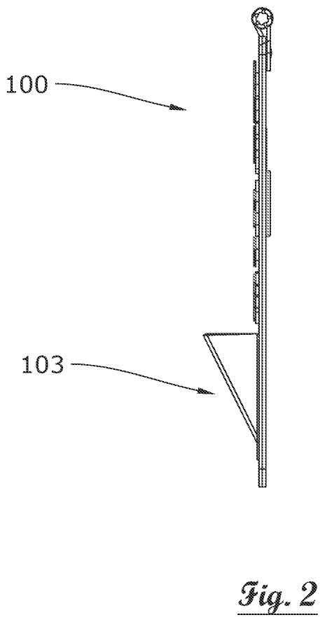

FIG. 2 shows a side-view of the apparatus 100, emphasizing the depth of a top opening of the pocket 103 for depositing and retrieving tags 104 for alternating storage and use. The body panel 101 is constructed of such material(s) and dimensions to have suitable strength to support the combined weight of the mirror 102 and a plurality of the tags 104 attached to the body panel 101 for display and/or stored in the pocket 103, while maintaining the vertical planar orientation of its front side 105. In other embodiments, an apparatus for promoting psychological well-being may include still other attachable elements and/or fixtures supported by a body member analogous to the body panel 101.

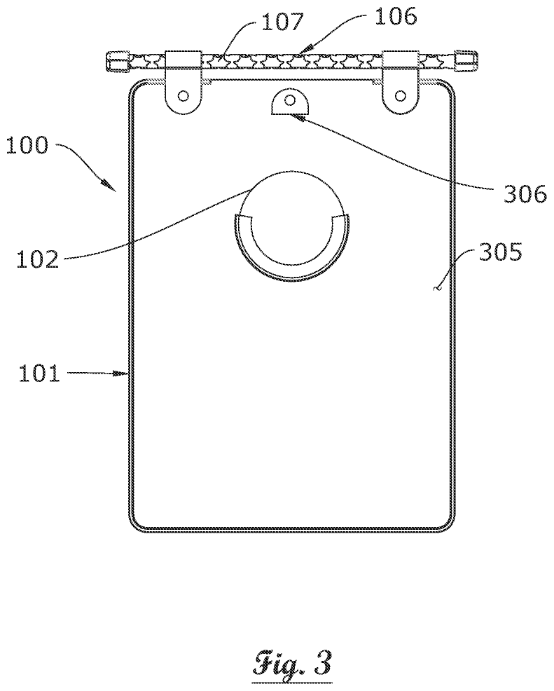

Turning now to FIG. 3, a rear view of the apparatus 100 is shown. As shown and considered in some embodiments, the mount 106 is adapted to suspend the apparatus 100 on a wall or external surface (not shown) and position the apparatus 100 at a suitable height relative to a user. The apparatus 100 further includes an additional wall mount 306 (optionally omitted) affixed to a rear surface 305 of the body panel 101. It is envisioned that apparatus according to embodiments may include one mount or more than one mount. In some embodiments, a rod or dowel analogous to the rod 107 comprises a part of the ornamental design of the apparatus and may not be functional. Not wishing to be bound by any particular theory, the mount 306 may be of the type selected from the group consisting of a magnet, a hanger (such as for hanging from a nail or picture hook), a bracket, a snap fit, a suction cup, a hook-and-loop fastener arrangement or the like. More preferably, the mount 306 is removably securable to the body panel 101 and/or to a complementary structure or feature of a fixed support, or the mount 306 comprises a complementary pair of structures that are removably securable to one another when one is affixed or secured to the body panel 101 and the other to a fixed support.

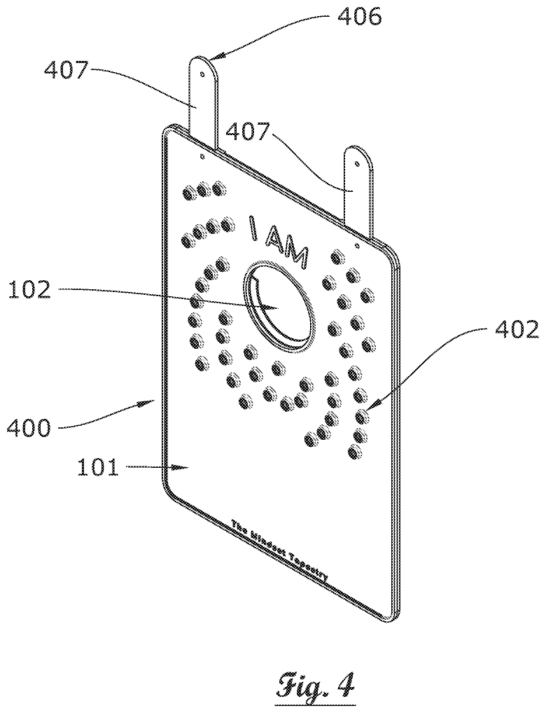

Turning now to FIG. 4, an isometric view of an apparatus 400 according to another embodiment is shown. As depicted in FIG. 4, the apparatus 400 includes the body panel 101 (omitting a pocket such as the pocket 103) and an alternative mount 406 connected thereto. The mount 406 comprises tabs 407, the tabs 407 illustrated as each including an eyelet, such as for receiving a hanging nail on a wall or an attached end of a string/wire/cord.

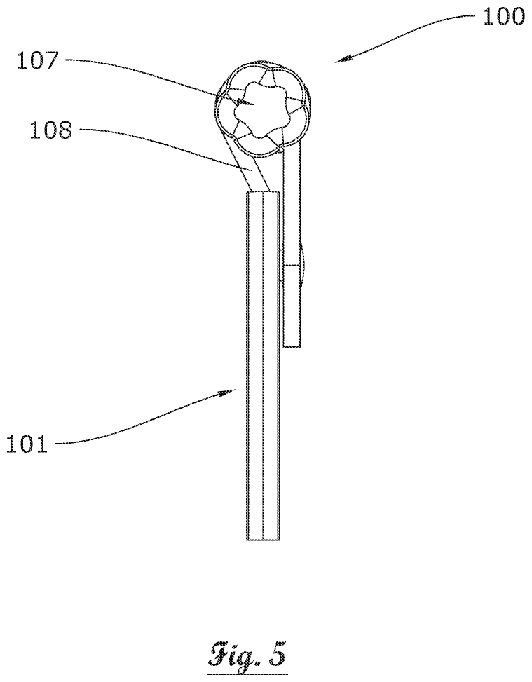

FIG. 5 depicts an enlarged, truncated side view of an upper end portion of the apparatus 100 as seen in FIG. 2, wherein it can be seen that the body panel 101 can have a forward-rearward depth dimension that is on the order of a diameter of the rod 107. In certain embodiments, a hanging rod or analogous mounting structure can be retained by an extension of a body panel of an apparatus for promoting psychological well-being, instead of by retaining brackets such as the retaining brackets 108. For example, where a body panel is formed of a fabric or cloth material, the body panel can be folded over and sewn to itself at its upper end to form a hem for receiving a hanging rod.

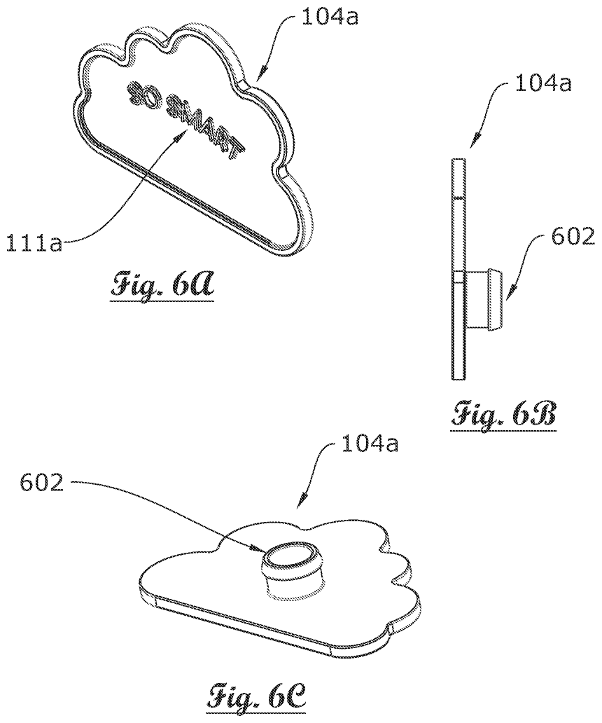

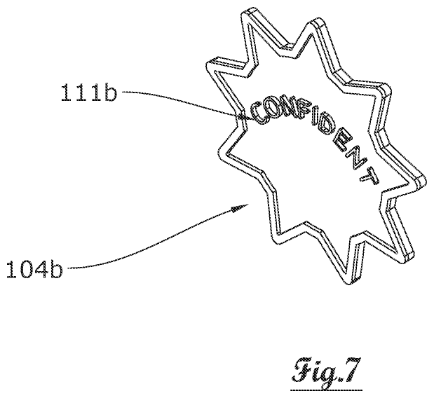

One of the tags 104 is shown in multiple views in FIGS. 6A-6C designated as a tag 104a bearing message indicia 111a, while another tag 104 is shown in a perspective view in FIG. 7 designated as a tag 104b bearing message indicia 111b. The message indicia 111a of the tag 104a is illustrated as lettering that forms the words “SO SMART.” In mindfulness apparatus according to other embodiments, tags can include message indicia selected from the group consisting of a picture, an image, an engravement, text, a phrase, or the like, disposed on a front side. As shown, the tag 104a includes a snap-fit tag mounting connector 602 on its rear side. Tag mounting connectors of other embodiments may include magnetic structures, hook-and-loop structures, or the like. Further, in some embodiments, it is envisioned that relationships among the tags (such as according to congruity, category, sequence, or hierarchy, as desired for a method of use of the apparatus) may be designated by one or more relational visible features separate from their message indicia. More particularly, the relational visible feature can comprise relational indicia, separate from the message indicia, displayed on the front side of a tag (such as numbers, as described in more detail further below with reference to an apparatus 900 for promoting psychological well-being, according to another embodiment) or an overall shape of the tag. The relational visible feature of a tag can help a user to order the tags according to a plan of use based on their message indicia, and/or to identify and sort the tags based on their message indicia being the same or related. Thus, in the apparatus 100 as illustrated in FIG. 1, the tags 104 include star-shaped tags 104, each bearing indicia 111 forming the word “BEAUTIFUL;” cloud-shaped tags 104, each bearing indicia 111 forming the words “SO SMART” (as in the tag 104a shown in FIGS. 6A-6C); and sun-shaped tags 104, each bearing indicia 111 forming the word “CONFIDENT” (as in the tag 104b shown in FIG. 7). It is envisioned that the various message content of the various indicia of various tags will be useful for fulfilling the intent of mindfulness apparatus according to embodiments of the disclosure.

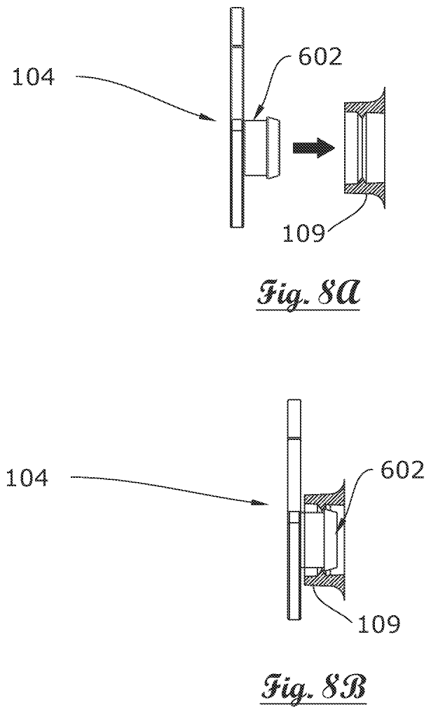

Illustrated in FIGS. 8a-8b is the attaching function of the tags 104. It is envisioned that a tag 104 may be removably snap-connected to tag holders 109 of the body panel 101 by aligning the mounting connectors 602 with the tag holders 109, as shown in FIG. 8A, and pressing the tag 104 forward to a snap-fit position shown in FIG. 8B. At a suitable later time (such as when a user wishes to display a different tag or set of tags 104, or to put all of the tags 104 away in the pocket 103 for storage), the tag 104 may then be pulled or pried rearwardly off of the tag holder 109 and optionally stored in the pocket 103.

Turning to FIGS. 9A and 9B, an apparatus 900 according to another embodiment is illustrated, of which it will be recognized that certain elements are designated by reference numerals having the same last two digits as those of certain analogous elements of the previously described apparatus 100.

As shown, the apparatus 900 includes a body panel 901, a mirror 902, a plurality of affirmation tags 904 bearing tag message indicia 911a and detachably attachable for display to a display tag holder 909 that circumscribes the mirror 902, a front side 905 having a frontal area encompassing a configurable display region 905a and a storage region 905b, and a mount 906 comprising an upper dowel 907 retained in a hem 908 formed in the body panel 901 and a string 912 attached at opposite ends to opposite ends of the dowel 907, so that the apparatus 900 can be secured to a fixed support such as the wall W (shown in FIG. 9B) by the dowel 907 being hung by the string 912 from a nail, hook or analogous structure (not shown).

As in the apparatus 100, the mirror 902 and tags 904 are disposed within the configurable display region 905a. Each tag 904 can be detachably attached to the tag holder 909 by pressing a rear side of the tag onto the tag holder 909, such as by a hook-and-loop fastener (for example, a Velcro® hook-and-loop fastener), of which one of the tag 904 and tag holder 909 comprises a hook patch and the other a complementary loop patch. It will also be understood that tags 904 can be attached to the tag holder 909 at a practically unlimited number of different locations, as the attachment mechanism works by overlapping attachment areas rather than by precise alignment of a single pair of mating features as in the apparatus 100. Similarly, in other embodiments a tag holder can be a magnetic strip (not shown) sized and shaped to allow attachment of a tag to the strip at any of a continuously varying range of positions thereon.

In the apparatus 900, a storage compartment comprises at least a portion of the storage region 905b covered by an openable and closable storage cover panel 903. Body panel message indicia 910, comprising the lettering “I am . . . ”, is disposed on an outer side of the storage cover panel 903, so as to be visible on the front side 905 of the body panel 901 only when the storage cover panel 903 is closed, as seen in FIG. 9A.

The storage cover panel 903 is shown in a closed position in FIG. 9A, and in an open position in FIG. 9B. The storage cover panel 903 can be opened by pulling a pull tab 913 (shown in FIG. 9A) to access a plurality of stored tags 904, which are stored by being detachably attached to first and second horizontally aligned, elongate stored tag holder strips 914a, 914b, such as by the same mechanism as their detachable attachment to the display tag holder 909. Further, the storage cover panel 903 includes a vertically aligned, elongate closure strip 916 along each opposite lateral edge of its inner side, each closure strip 916 extending downwardly from the hinge 917 when the cover panel 903 is open, as shown in FIG. 9B. The apparatus 900 further includes a closure strip 921 complementary to each closure strip 916, for example, one of the strips 916, 921 being a hook patch and the other a loop patch of a hook-and-loop fastener, the closure strip 921 extending along each opposite lateral edge of the front side 905 in the storage region 905b upwardly from the hinge 917. In the closed position of the storage cover panel 903, the cover panel 903 is releasably secured to the front side 905 of the body panel 901, so as to cover the storage region 905b, by the closure strips 916 being pressed against the closure strips 921. Alternatively, the closure strips 921 can be omitted and a hook-and-loop fastener connection formed where the vertically extending closure strips 916 intersect portions of the horizontally extending stored icon holder strips 914a, 914b near each of their opposite ends. The storage cover panel 903 is attached to the body panel 901 at a hinge 917 disposed at a lower end of the front side 905 of the body panel 901, the storage cover panel 903 being operative to pivot open and closed about the hinge 917. More particularly, the body panel 901 and the storage cover panel 903 are comprised in a single sheet of material that is folded over and stitched to itself at a seam defining the hinge 917, thereby forming a horizontally extending hem 918, the hem 918 being operative to retain a lower dowel 919, so that the weight of the lower dowel 919 pulls the body panel 901 taut between the upper dowel 907 and lower dowel 919, thereby helping to keep the front side 905 flat over the interactive and storage regions 905a, 905b during use, as well as anchoring the hinge 917 during opening and closing of the storage cover panel 903.

The tags 904 comprise relational visible features, including both a shape feature of each tag 904 and relational indicia displayed thereon, to facilitating identifying, sorting, and/or ordering the tags 904 according to their message indicia 911a, as will now be described.

Each tag 904 has either a first end feature 915a of a first shape or a second end feature 915b of a second shape. A first plurality of the stored tags 904, having the first end feature 915a, are detachably attached to the first stored tag holder strip 914a, and a second plurality of the stored tags 904, having the second end feature 915b, are detachably attached to the second stored tag holder strip 914b. Still more particularly, the first end feature 915a is an inwardly extending notch, and the second end feature 915b is an outwardly extending arrow tip. According to an embodiment, the inward notch 915a can serve to remind a user of the self-focused character of certain positive attributes or psychological states represented by the tag message indicia 911a of the first plurality of tags 904, such as “LOVED,” “SAFE,” “FREE,” and “CONFIDENT.” In turn, the outward arrow tip 915b serves to remind a user of the other-focused nature of certain positive attributes or states represented by the tag message indicia 911a of the second plurality of tags 904, such as “ACCEPTING,” “CARING,” and “SUPPORTIVE.”

In addition, each tag 904 bears relational indicia 911b on its front side, the relational indicia 911b being separate from the message indicia 911a. More particularly, as shown in FIG. 9B, the relational indicia 911b comprise a unique number on each tag 904, so as to define a sequential order or hierarchy of the tags 904. In turn, the sequential order or hierarchy of the tags 904 can determine a manner of their use in certain embodiments of a method according to this disclosure.

Finally, in addition to the stored tag holder strips 914a, 914b, the apparatus 900 further includes pockets 920 formed on the front side 905 of the body panel 901 along the lower end of the configurable display region 905a, where the latter meets the upper end of the storage region 905b. The pockets 920 have open tops and closed bottoms and are exposed even when the panel 903 is closed. Thus, in a method according to an embodiment, a user can quickly deposit and retrieve tags 904 from the pockets 920 without opening the panel 903, such as a certain subset of the tags 904 that the user is currently working with. In other embodiments, the pockets 920 can also retain a plurality of cards (not shown), which may comprise message or instructional indicia printed on cardstock, for use in conjunction with any method described herein.

In a method for encouraging positive psychological development according to this disclosure, an apparatus according to this disclosure is used to encourage positive psychological development. The method can be performed in or in conjunction with classroom instruction and/or individual or group psychotherapy or psychological wellness routines. The method includes a user (such as a child/student or psychotherapy patient or client) selecting a tag having suitable message indicia, reciting a message represented in whole or in part by the message indicia, looking into the mirror, attaching the selected tag to the tag holder in the interactive region. In embodiments, the foregoing steps are repeated on a regular basis, such as daily, or more particularly at the beginning of each day. The method can further incorporate interactions or check-ins with a caregiver during or regarding the daily routine.

In other embodiments, an apparatus for promoting psychological well-being is an electronic device comprising a user interface including at least one suitable interactive control, such as a “hard” button or switch, a touch control, a speech recognition/voice control, or a wired or wireless remote control signal receiver. In certain embodiments, an electronic device may incorporate by an electromechanical device incorporating mechanical apparatus of, or analogous to that of, any of the above-described apparatus embodiments. For example, the device can incorporate physical tags, each tag being operative, when attached to a display tag holder, to configure an interactive control, when activated, to cause an audio device to play an audio message corresponding to indicia displayed on the tag. When multiple tags are so attached, the interactive control may cause the audio device to play one, or up to as many as all, of the corresponding messages on each activation. For example, in embodiments where one of the messages is played on each activation of the control, the message played may be determined by a processor of the apparatus selecting from the messages corresponding to the attached tags, for example at random or following a programmed sequence.

In certain other embodiments, the mindfulness apparatus is a purely or primarily electronic device, such as a smartphone, tablet, or similar electronic device running an app which may graphically simulate the “tapestry” form of the apparatus according to embodiments described above and illustrated in the drawings. Thus, in one example, the app can be programmed to display an image similar to a front view of the apparatus 100 or 900, including an area representing the mirror, wherein a real-time video-captured image of the user facing the camera of a device running the app can be displayed during use. The user can interact with a touchscreen of the device to manipulate selected tags, such as by touching and dragging the selected tag to or from a tag “holder” in a display region, or similarly to or from the storage region. Having thus “attached” a desired selection of the tags in the display region, the user may then activate the interactive control to play one or more of the corresponding messages substantially as described above. In still more particular embodiments, the method further includes repetition of the foregoing steps at regular time intervals, such as daily, or more particularly at the beginning of each day. A processor of the device running the app can record and/or track or count each recitation of each phrase over time. In addition to the “tapestry” image, the app user interface can also display a calendar. In embodiments, a second user can use the app to track the above described interactions of a first user with the app. More particularly, a system based on the app may operate over a computer network, such as the internet, and may use one or more servers to administer profiles of the first and second user. The second user can be, for example, a caregiver, and the second user's profile can be of a different system-defined class than that of the first user, associated with different user experiences and interfaces.

Embodiments of the present disclosure are described herein, including the best mode known to the inventor(s) for carrying out the disclosure. Variations of these embodiments may become apparent to those of ordinary skill in the art upon reading the foregoing description. The inventor(s) expect skilled artisans to employ such variations as appropriate, and the inventor(s) intend for the disclosure to be practiced otherwise than as specifically described herein. Accordingly, this disclosure includes all modifications and equivalents of the subject matter recited in the Embodiments appended hereto as permitted by applicable law. Moreover, any combination of the above-described elements in all possible variations thereof is encompassed by the disclosure unless otherwise indicated herein or otherwise clearly contradicted by context.

While this disclosure may be embodied in many different forms, there are described in detail herein specific preferred embodiments of the disclosure. The present disclosure is an exemplification of the principles of the disclosure and is not intended to limit the disclosure to the particular embodiments illustrated. All patents, patent applications, scientific papers, and any other referenced materials mentioned herein are incorporated by reference in their entirety. Furthermore, the disclosure encompasses any possible combination of some, or all of the various embodiments mentioned herein, described herein and/or incorporated herein. In addition, the disclosure encompasses any possible combination that also specifically excludes any one or some of the various embodiments mentioned herein, described herein and/or incorporated herein.

Any information in any material (e.g., a United States patent, United States patent application, book, article, etc.) that has been incorporated herein is only incorporated by reference to the extent that no conflict exists between such information and the other statements and drawings set forth herein. In the event of such conflict, including a conflict that would render invalid any embodiment described herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the Embodiments where the term “comprising” means “including, but not limited to.” Those familiar with the art may recognize other equivalents to the specific embodiments described herein which equivalents are also intended to be encompassed by the Embodiments.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

This completes the description of the preferred and alternate embodiments of the disclosure. Those skilled in the art may recognize other equivalents to the specific embodiment described herein which equivalents are intended to be encompassed by the Embodiments attached hereto.

What is claimed is:

1. An apparatus comprising:
a body panel, the body panel having a front side defining a forward direction, an upper end defining a vertical upward direction, a lower end defining a vertical downward direction, lateral sides defining opposed lateral directions, and a rear side defining a rearward direction, the front side including a configurable display region and a storage region, a frontal area of the front side encompassing a frontal area of the configurable display region and a frontal area of the storage region;
at least one mirror disposed in the configurable display region;
a plurality of tags, each tag having a front side bearing message indicia;
at least one tag holder disposed on the front side of the body panel in the configurable display region, each tag being detachably attachable to the at least one tag holder so that the front side of the tag faces forward;
a storage compartment disposed in the storage region, the storage compartment being configured to store at least one tag.

2. The apparatus of claim 1, wherein the storage compartment comprises a pocket connected to the body panel, the pocket having a top opening operative to permit the at least one tag to be deposited in and removed from the pocket through the top opening.

3. The apparatus of claim 1 wherein the at least one tag holder comprises a plurality of attachment locations, each tag being selectively attachable to the at least one tag holder at each of the attachment locations.

4. The apparatus of claim 3 wherein the at least one tag holder comprises a plurality of tag holders, the tag being selectively attachable to each of the tag holders at one of the attachment locations.

5. The apparatus of claim 1, further comprising a mount; the mount being adapted and configured to support the body panel front surface in a vertical orientation when the mount is secured to a fixed support.

6. The apparatus of claim 4, wherein the mount comprises a rod.

7. The apparatus of claim 4, wherein the mount comprises a string.

8. The apparatus of claim 1, wherein said body panel constructed of a material selected from the group consisting of wood, metal, polymer, and cloth.

9. The apparatus of claim 1, wherein said message indicia include words associated with psychological well-being.

10. The apparatus of claim 1, wherein said tag further comprises a magnet.

11. The apparatus of claim 1, wherein said tag further comprises a suction cup.

12. The apparatus of claim 1, wherein the storage compartment comprises a storage cover panel, the storage cover panel being pivotally connected to the body panel by a hinge for pivoting between an open position and a closed position, the storage cover panel in the closed position being releasably secured to the body panel by a latch.

13. The apparatus of claim 12, wherein said latch includes a hook-and-loop fastener.

14. The apparatus of claim 1, wherein each tag comprises a visible feature for ordering the tag relative to the other tags, the visible feature being separate from said message indicia.

15. The apparatus of claim 14, wherein the visible feature comprises a shape of the tag, the tags comprising tags of at least two visually distinguishable shapes.

16. The apparatus of claim 14, wherein the visible feature comprises relational indicia separate from said message indicia.

17. A method for encouraging positive psychological development comprising using the apparatus of claim 1 to encourage positive psychological development, the method comprising:
selecting a tag having suitable message indicia;
reciting a message represented by the message indicia;
looking into said mirror; and
attaching the selected tag to the tag holder.

18. The method of claim 17, wherein said selecting, reciting, looking, and attaching are repeated at regular time intervals.
